(19) United States
(12) Patent Application Publication
(10) Pub. No.: US 2017/0048167 A1
(43) Pub. Date: Feb. 16, 2017

(54) FLOOD DISABLE ON NETWORK SWITCH

(71) Applicant: HEWLETT PACKARD ENTERPRISE DEVELOPMENT LP, Houston, TX (US)

(72) Inventors: Justin E. York, Cypress, TX (US); Andy Brown, Houston, TX (US)

(21) Appl. No.: 15/306,549

(22) PCT Filed: Apr. 30, 2014
(86) PCT No.: PCT/US2014/036064

§ 371 Date: Oct. 25, 2016

(51) Int. Cl. H04L 12/947; H04L 29/08; H04L 12/24; H04L 12/721; H04L 29/12

(52) U.S. Cl. CPC H04L 49/25; H04L 45/32; H04L 61/6022; H04L 41/08; H04L 67/146

(57) ABSTRACT

Techniques related to network switch flooding are described. in one aspect, a network switch may receive a plurality of node identifiers. The node identifiers may identify nodes reachable via a port of the switch. Flooding on the port may be disabled. Traffic destined for nodes reachable via the port may be sent on the port.

### BACKGROUND

Modern high performance computing systems may include a chassis which houses multiple computing resources. These computing resources may be in the form of cartridges. In essence, each cartridge may be an independent computer, and contain many of the elements that make up a computer. For example, each cartridge may include one or more processors, memory, persistent storage, and network interface controllers. Each cartridge may include all or only some of the previously mentioned elements.

In addition, the chassis itself may provide resources that are shared by the cartridges within the chassis. For example, the chassis may provide one or more power supplies, which may be used to power the cartridges. Likewise, the chassis may provide cooling resources, such as fans, to cool the chassis and the cartridges within the chassis. The chassis may also provide networking resources to allow the cartridges to communicate with computing resources located both within and external to the chassis.

### BRIEF DESCRIPTION OF THE DRAWINGS

FIG. 1 depicts an example of a system which may utilize flood disabling on a network switch techniques described herein.

FIG. 2 is an example of a high level flow diagram for utilizing flood disabling on a port of a network switch using the techniques herein.

FIG. 3 is another example of a high level flow diagram for utilizing flood disabling on a port of a network switch using the techniques herein.

FIG. 4 is an example of a high level flow diagram for utilizing a management controller according to the flood disabling techniques described herein.

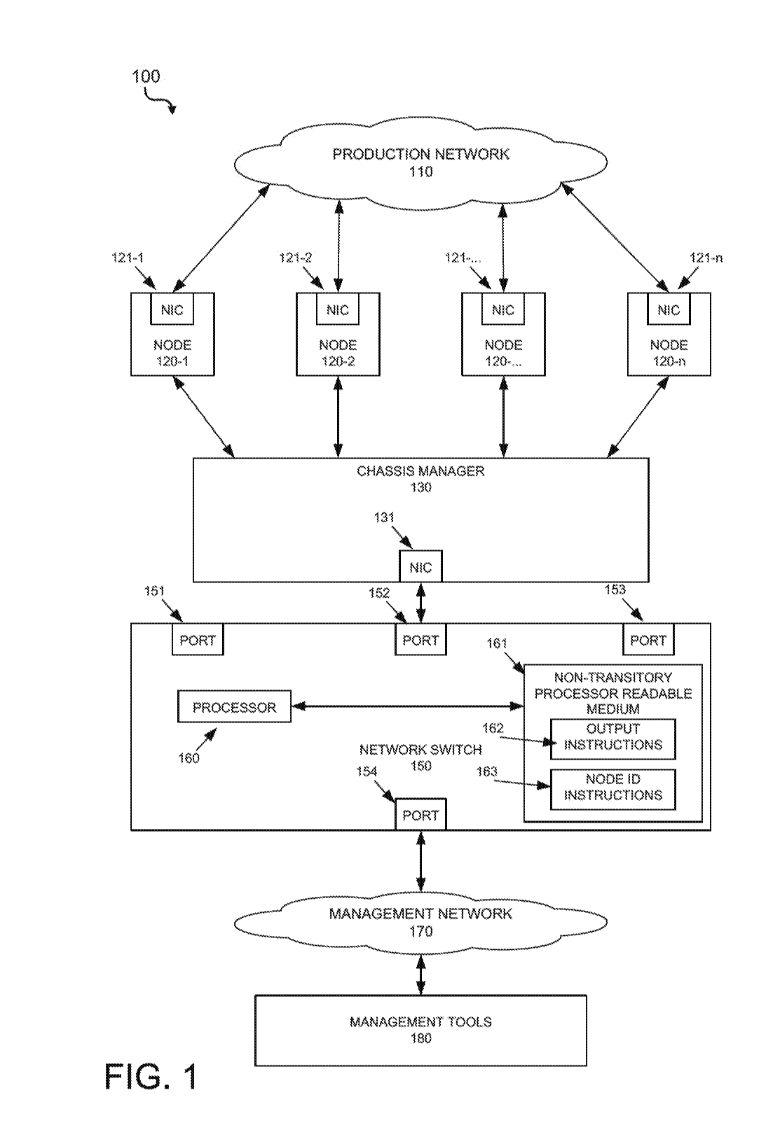

FIG, 5 is another example of a high level flow diagram for utilizing a management controller according to the flood disabling techniques described herein.

### DETAILED DESCRIPTION

In some cartridge based system, the one to one relationship of some components may no longer exist. For example, in a baseboard based server computer, a management controller, often referred to as a Baseboard Management Controller (BMC) may be included for each baseboard. Because each baseboard is for all intents and purposes a separate server, there may have been a one to one relationship of BMC to server. External management software may rely on this relationship in order to manage the server,

The one to one relationship between management controller and server may no longer exist in cartridge based systems. For example, a single management controller, which may also be referred to as a chassis manager, may be responsible for providing functionality similar to a BMC for more than one cartridge in a chassis. Thus, even when a single cartridge contains a single server, the one to one relationship of a management controller to a server no longer exists. Because this relationship no longer exists, management software relying on the one to one relationship may no longer function properly.

To add further complexity to the system, some cartridge based systems may include more than one server on a single cartridge. System on a Chip (SoC) technology has allowed for substantially all of the components of a server to be contained within a single chip, thus eliminating the need for independent chipsets and network interface controllers. All of those functions may be integrated within a chip. A cartridge may include multiple Systems on a Chip, which essentially removes the one to one relationship between a cartridge and a server. Now, a cartridge may contain as many servers as it contains systems on a chip.

Systems on a chip present additional problems in terms of interfacing with management software because certain functionality that may exist in baseboard based servers does not exist in SoC systems. For example, the ability to power a portion of a baseboard based system allows those systems to continue to supply power to the network interface controller (NIC) even when the rest of the baseboard based server is powered off. The NIC may then listen for a Wake on LAN (WoL) packet, often referred to as a magic packet, which is a special packet addressed to the NIC. Upon receipt of the packet, the NIC may trigger the remainder of the server to return to a powered state (i.e. wake up).

SoC systems may lack the ability to selectively power certain portions of the chip, such as the NIC. In many SoC systems, the system is either on or off. Because the ability to power the NIC separate from the rest of the system may not be available, SoC systems may not be able to respond to WoL packets in the same way as baseboard based systems. Because the SoC is ether fully on or fully off, there is no ability to enter a reduced power state while still allowing for the ability to be woken up using a WoL. magic packet.

In some implementations of chassis based systems, the NIC of the chassis manager may be placed into promiscuous mode. Thus, all traffic on the network connected to the NIC of the chassis manager is passed to the operating system running on the chassis manager. An application running on the chassis manager may then determine if a particular packet, such as a magic packet, is destined for one of the servers that is managed by the chassis manager. If so, the chassis manager may forward the packet to the server. For example, management software may be configured to think it is communicating with a BMC on a server. The chassis manager may receive this communication, because it is operating in promiscuous mode, and determine that the communication is intended for one of the servers managed by the chassis manager. The management software need not be aware that it is not directly communicating with a BMC based system.

In the case of a SoC based system, forwarding the packet may first include the chassis manager powering up the SoC. As mentioned above, many SoC systems may lack the ability to remain partially on in order to receive a magic packet. Because the chassis manager NIC may be in promiscuous mode, a magic packet destined for the NIC of the SoC may be received by the chassis manager. The chassis manager may be aware that the packet was destined for a SoC that is managed by the chassis manager. The chassis manager may then cause the SoC to wake up.

Although the technique of putting the chassis manager NIC into promiscuous mode may solve some of the problems described above, it also creates new problems. For example, when a chassis manger NIC is put into promiscuous mode, every packet received by the NIC causes an interrupt to be generated for the chassis manager. The operating system on the chassis manger must then handle the interrupt by retrieving the packet, determining if it is destined for a server managed by the chassis manager, and if not, discard the packet. Because the NIC is no longer filtering irrelevant packets, the burden is placed on the chassis manager's central processing unit. Thus interrupt handling could exhaust all available processing capacity on the chassis manager.

The techniques described herein overcome the problems described above by including a network switch between the NIC of the chassis manager and the network that is ultimately connected to the chassis manager. The network switch may be informed of the MAC addresses of all servers that are managed by the chassis manager. The network switch may then disable flooding on the port connected to the chassis manager, with the exception that packets destined for servers managed by the chassis manger or the chassis manager itself are still sent to the chassis manager. The NIC associated with the chassis manager may then still be placed into promiscuous mode. Because the network switch has filtered all packets not intended for a server connected to the chassis manager or the chassis manager itself, any packet that is received by the chassis manager is destined for either the chassis manager itself or a server associated with the chassis manager. In order to further reduce the load on the chassis manager, further filtering may be performed by the switch to only allow packets that meet certain criteria to proceed along to the chassis manager. For example, only magic packets may be allowed to proceed to the chassis manager. As another example, the switch may limit the rate at which packets may be sent to the chassis manager. Furthermore, management software attempting to communicate with a server need not be aware that it is not communicating with a BMC. From the perspective of the management software, it is communicating with a baseboard based system, even though in reality it is not. As such, no changes to the management software are needed. These techniques are described in further detail below and in conjunction with the appended figures.

FIG, 1 depicts an example of a system which may utilize the flood disabling on a network switch techniques described herein. System 100 may include a production network 110, nodes 120-1 . . . n, a chassis manger 130, a network switch 150, and a management network 170, and management tools 180.

Nodes 120-1 . . . n may be substantially equivalent to a server computer. For purposes of this description, a node may be a server that management tools treat as if there is a one to one relationship between the node and a management controller. In other words, from the perspective of the management tools, each node is associated with a BMC, and that BMC may be communicated with directly over the management network 170. The management tools need not be aware that each node does not actually have its own dedicated management controller. Furthermore, the node to cartridge layout is unimportant. Each node may reside on a separate cartridge, multiple nodes may reside on the same cartridge, or any combination thereof. What should be understood is that regardless of physical placement, each node is viewed by the management tools as an individual server that may be managed through a BMC, regardless of the actual physical configuration of the node.

Each node 120-1 . . . n may include a NIC 121-1 . . . n. The NIC may couple the node to a network, such as production network 110. The production network may allow communication between the node and other computing systems. For example, the production network may be an intranet or the Internet, Each NIC may include an identifier that allows the node to be identified on the production network. For example, in the case of an Ethernet based production network, the identifier may be a Media Access Control (MAC) address. The MAC address may allow the node to be uniquely identified on the production network. The techniques presented herein are not dependent on any particular type of identifier, What should be understood is that the identifier allow the node to be uniquely identified on a network. In addition, although each node is only shown as containing a single NIC, this is for purposes of ease of description and not by way of limitation. A node may have multiple NICs connected to the production network, each including an identifier the uniquely identifies the NIC of the node.

System 100 may also include a chassis manager 130. The chassis manager may provide functionality that is similar to that provided by a BMC. In other words, the chassis manger may include the ability to power on off nodes, retrieve operating statistics from the nodes, provide remote keyboard/video/mouse (KVM), for the nodes, and any other functions that may be provided by a BMC. However, unlike a BMC associated with a single server, the chassis manager may be associated with multiple nodes, and provide BMC like functionality for a plurality of nodes. By consolidating BMC functionality for multiple nodes onto a single chassis manager, the cost for each node may be reduced, as an individual BMC is not needed for each node.

The chassis manager may be coupled to each of the nodes that is managed by the chassis manager. In some example implementations, the coupling may be through direct connection while in other example implementations the coupling may be through a network, such as a private network (not shown). Techniques described herein are not dependent on any particular type of coupling. What should be understood is that the chassis manager is able to assert the same type of control over a node as a BMC is able to assert over a baseboard based server.

The chassis manager may also include a NIC 131. The NIC 131 may allow the chassis manager to communicate with an external network, such as the management network 170. As above, the NIC may have an identifier, such as a MAC address, The NIC 131 may be coupled to a network switch 150, which is described below. Traffic from the management network destined for the chassis manager or for one of the nodes may be received at the NIC of the chassis manager.

System 100 may include a network switch 150. The network switch may provide a plurality of ports 151-154. The network switch may also include a processor 160 coupled to a non-transitory processor readable medium 161. The medium 161 may include thereon a set of instructions, which when executed by the processor, cause the processor to implement the techniques described herein. For example, the medium 161 may include output instructions 162 which may determine how traffic received at one port is output on a different port. The medium 161 may also include node ID instructions 163 which may determine how node to port associations are maintained. Operation of the network switch is described in further detail below.

System 100 may also include a management network 170. The management network 170 may provide similar functionality as the production network 110. In some example implementations, the management network and the production network may actually be the same network. Coupled to the management network may be management tools 180. The management tools may be management software that is running on a computing system. The particular operational environment of the management tools is relatively unimportant. However, what should be understood is that the management tools may be of such a type that the tools assume they are communicating with a server which includes a BMC. The management tools need not be aware of the actual architecture of system 100.

In operation, the chassis manager 130 may determine all of the nodes 120-1 . . . n that are managed by the chassis manager. For example, the chassis manager may query each node or may be pre-configured with information identifying each connected node. The techniques described herein are not dependent on an particular mechanism for the chassis manager determining which nodes are managed by the chassis manager. What should be understood is that the chassis manager is able to determine all nodes managed by the chassis manager.

In addition, the chassis manager may obtain an identifier for each node that may uniquely identify each node. For example, the chassis manager may obtain the MAC address of the NIC 121-1 . . . n for each node 120-1 . . . n. Although a MAC address is one form of an identifier, it should be understood that the techniques described herein are not dependent on use of a MAC address. Any other identifier may be used as well.

The chassis manager 130 may be coupled to the network switch 150 over port 152 of the network switch. The chassis manager may notify the network switch of all nodes that are managed by, and are thus reachable via, the chassis manager. In one example implementation, the chassis manager may send one packet for each managed node to the network switch over port 152. The packet may include the node identifier (e.g. MAC address), The network switch may then, using the node ID instructions, establish an association between the port 152 and each node for which a packet is received,

In another example implementation, the chassis manager may use a direct connection (not shown) to transmit the node identifier information to the network switch. in other words, the chassis manager may inform the network switch as to which nodes are managed by the chassis manager, the identifiers for those nodes, and the port over which the chassis manager can be reached. Again, the network switch may establish an association between the port coupled to the chassis manager and the nodes reachable via the port connected to the chassis manager. Regardless of how the information is obtained by the network switch, the network switch receives the node identifiers for each node managed by the chassis manager, and the network switch associates those node identifiers with the port coupled to the chassis manager.

The network switch may then disable flooding for the port associated with the chassis manager. Flooding is a technique whereby if the network switch receives a packet including an identifier for which the network switch does not have an association with a port, the network switch sends the packet on all ports. For example, if a network switch receives a packet including an identifier on port 154, but does not have an association of that identifier with any other port, the network switch will flood the packet by sending the packet out on all ports other than the one over which it was received. In this case, the networks switch would flood the packet to ports 151-153, In other words, if the network switch does not have an association of an identifier with a port, the network switch sends the packet on every port, with the hope that some component connected to one of the ports may know how to reach the node including the identifier in the packet. The techniques described herein disable flooding for a port that is connected to a chassis manager.

When a packet is received by the network switch, the network switch checks, using the output instructions 162, if there is an association between the node identifier contained in the packet an one of the ports 151-154. If there is no previously established association, the network switch floods the packet onto all ports for which flooding has not been disabled. If there is a previously established association, the network switch outputs the packet on the port including the association.

The NIC 131 of the chassis manager may then be placed in promiscuous mode, In promiscuous mode, every packet received by the NIC 131 will be passed to the operating system of the chassis manager for examination to determine if it is destined for a node managed by the chassis manager. However, as explained above, the network switch filters packets such that only packets that include identifiers associated with nodes managed by the chassis manager and the chassis manager itself are ever sent on the port connected to the chassis manager. Thus, even though the NIC of the chassis manager is in promiscuous mode, only packets destined for nodes managed by the chassis manager and the chassis manager itself are ever received. Therefore, even though the chassis manger receives an interrupt for every packet received by the NIC, the filtering performed by the network switch ensures that every packet that makes it to the chassis manager should actually be forwarded by the chassis manager to one of the nodes. As such, the chassis manager is not burdened by handling interrupts for packets that will be discarded.

Management tools 180 may desire to send a management operation to one of the nodes 120. One example of such a management operation may be a Wake on Lan (WoL) operation. A WoL operation may include a packet, often referred to as a WoL packet, or magic packet, that includes the MAC address of NIC 121 on the production network. In a non-SoC based system, the magic packet may be sent on the production network, and when received by the NIC of the node, may cause the node to wake up. However, as mentioned above, in SoC based systems, it may not be possible to separately power the NIC, and as such a magic packet sent on the production network would not be received.

The management tools may instead send the magic packet on the management network 170, the packet including the MAC address of the NIC of one of the nodes on the production network. The magic packet may be received by the network switch 150, over port 154. The network switch may then examine the packet to determine if the MAC address included in the magic packet has been previously associated with one of the ports. If not, the packet may be flooded onto all ports for which flooding has not been disabled. IN the present example, this means that if the node for which a magic packet is received has not been previously associated with port 162, then the packet will not be sent on port 152, as flooding on that port has been disabled.

If there has been a previous association of the node identifier contained in the packet with a port, the network switch may forward the packet on that port. In this case, if the magic packet was destined for one of the nodes managed by the chassis manger, the association between the node and the port would have already been established, as described above. Thus the network switch would output the packet on port 152.

Because the NIC 131 of the chassis manager 130 has been placed into promiscuous mode, the magic packet will not be rejected by the NIC 131, even though the MAC address in the magic packet is not the MAC address of the NIC 131, Instead, NIC generates an interrupt, and passes the packet to the operating system of the chassis manager for further processing. The chassis manager is aware of the nodes that it manages, and is thus able to correlate the identifier contained in the magic packet with the proper node. In some cases the chassis manager may then forward the packet to the proper node. In other cases, the packet may not be forwarded, but rather is acted upon by the chassis manager itself. For example, in the case of a magic packet destined for a node, the chassis manager may itself cause the node to power on.

Although the previous description was described in terms of a WoL packet, using MAC addresses as identifiers, it should be understood that the techniques described herein are not so limited. What should be understood is that the NIC of the chassis manager may be placed into promiscuous mode, while the network switch ensures that only packets that can actually be operated on by the chassis manager are ever received by the chassis manager. Thus, other identifiers may also be used. For example, the network switch may also filter on IP addresses as opposed to MAC addresses, and the chassis manager informs the network switch of the IP addresses of all of the nodes managed by the chassis manger.

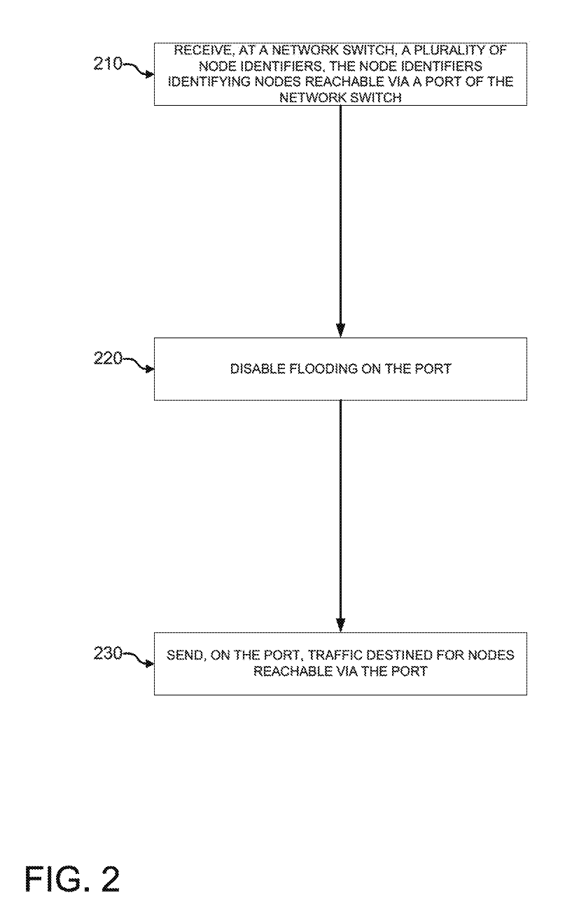

FIG. 2 is an example of a high level flow diagram for utilizing flood disabling on a port of a network switch using the techniques herein. In block 210, a plurality of node identifier may be received at a network switch. The node identifiers may identify nodes reachable via a poll of the network switch. As explained above, each node may have a node identifier that uniquely identifies the node. The identifier may be a MAC address of the node's NIC connection to the production network or any other type of address that may be associated with the node. What should be understood is that the node identifier is what allows the chassis manager to determine to which node any given communication is destined.

In block 220, flooding may be disabled on the port. In other words, flooding of traffic destined for unknown destinations may be turned off for the port that is described above. Because flooding is turned off for the port, if the network switch may no longer send traffic on the port in cases where the network switch does not have information indicating that the desired destination node is reachable via the port. In block 230, traffic destined for nodes reachable via the port may be sent on the port. In other words, traffic destined for nodes that were identified in block 210 may be sent on the port. However, if the network switch does not have information indicating a destination node is reachable via the port, the traffic is not sent over that port because flooding for the port was turned off in block 220.

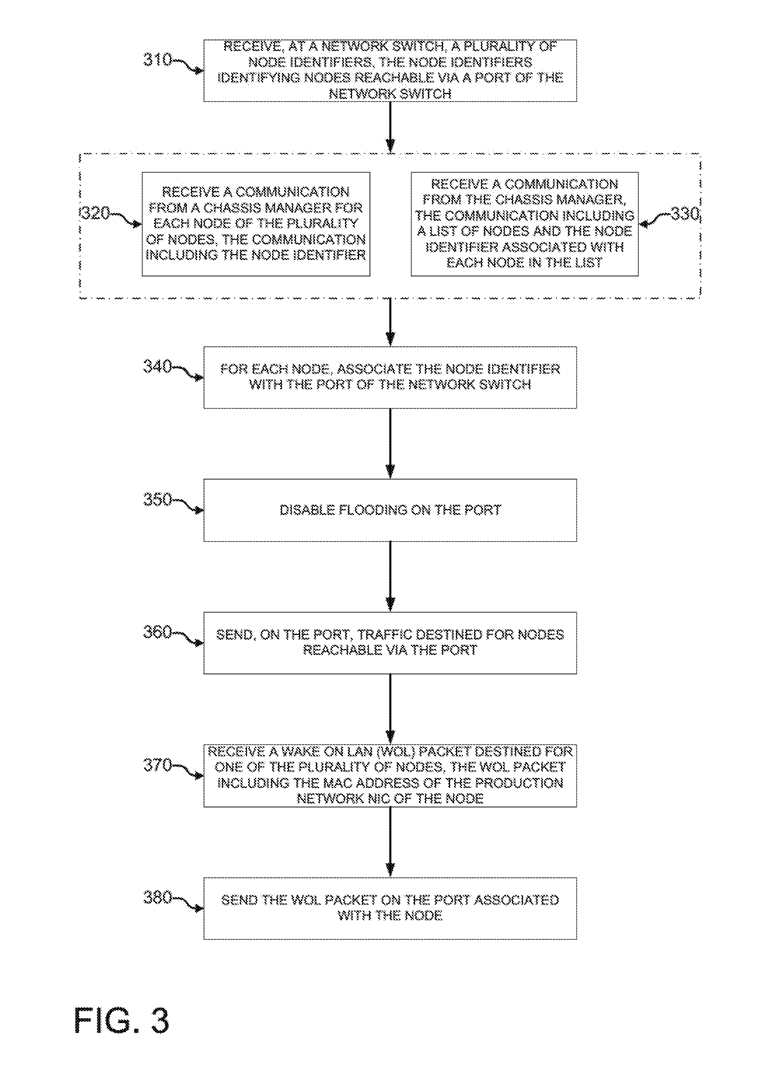

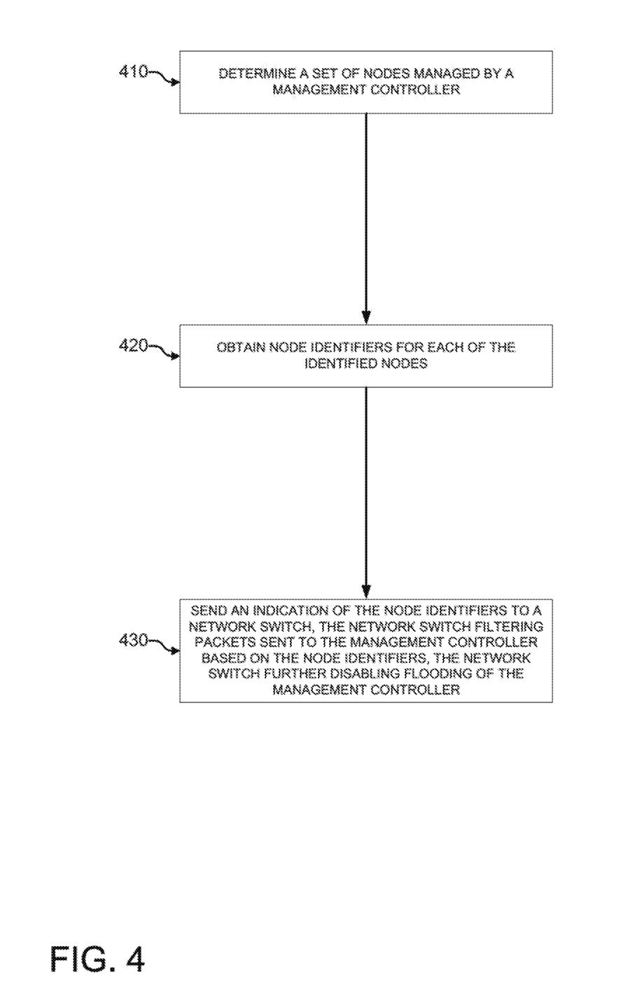

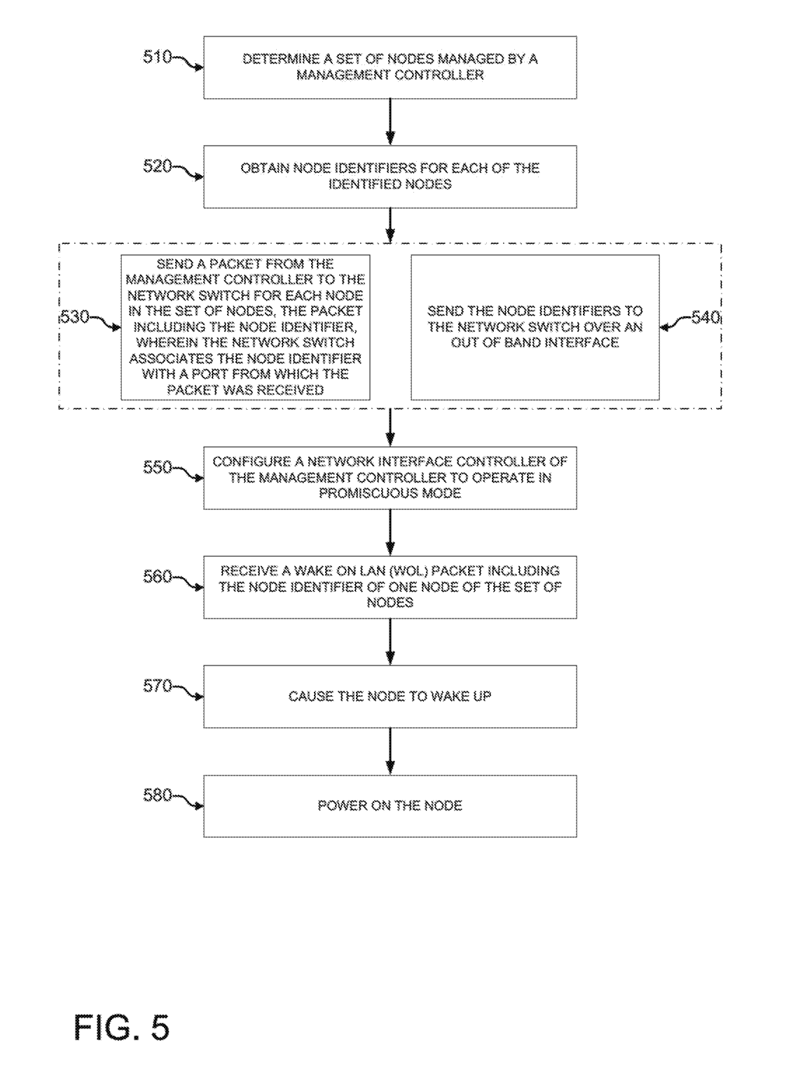

FIG. 3 is another example of a high level flow diagram for utilizing flood disabling on a port of a network switch using the techniques herein. In block 310, just as above in block 210, a plurality of node identifiers may be received at a network switch. The node identifiers may identify nodes reachable via a port of the network switch.

There may be multiple ways in which the node identifiers may be received by the network switch. One example implementation is described in block 320, in which a communication from a chassis manager may be received for each node of the plurality of nodes. The communication may include the node identifier. In other words, the chassis manager may send a communication, such as a packet, containing the node identifier for each node reachable through the port. The network switch may then associate the node identifiers with the port, just as if the node itself had sent the packet.

Another example implementation is described in block 330, in which a communication may be received from the chassis manager, the communication including a list of nodes and the node identifier associated with each node. Because the chassis manager may be aware of all nodes reachable through it, the chassis manager may simply send the list of nodes and the associated identifiers to the network switch. In one example implementation, the list may be sent from the chassis manager to the network switch on the pod connecting the two. In other implementations, the chassis manager may send the list over an out of band interface. What should be understood is that the chassis manager may be able to inform the switch of all reachable nodes without sending an individual communication for each node, as was the case in block 320.

In block 340, for each node, the node identifier may be associated with the port of the network switch. In other words, after receiving an indication of which nodes are reachable through the port, the node identifiers for those nodes may then be associated with the port. The association of node identifiers with the port may be used to determine if traffic is sent to a particular port, as will be described later. In block 350, just as above in block 220, flooding on the port may be disabled.

In block 360, traffic destined for nodes that are reachable via the port are sent on the port. In other words, the associations of nodes identifiers with the port is used to determine if traffic is to be sent on the port. Because flooding was disabled in block 350, if there is no association of the node identifier with the port, the traffic will not be sent on the port. As mentioned above, because only traffic destined to nodes reachable via the port is sent on the port, a NIC on the receiving end of traffic from the port can be placed into promiscuous node without causing performance issues.

In block 370, a wake on LAN (WoL) packet destined for one of the plurality of nodes may be received. The WoL packet may include the identifier of the node. For example, the WoL packet may include the MAC address of the production network NIC of the node, Regardless of the particular identifier, the WoL may include the node identifier. In block 380, the WoL packet may be sent on the port associated with the node. Because the node identifier was associated with the port above in step 340, when a WoL packet is received he packet is only sent on the port through which the node is reachable. Upon receipt of the WoL packet, the chassis manager may cause the node to wake up. For example, the chassis manager may cause the node to power on.

FIG, 4 is an example of a high level flow diagram for utilizing a management controller according to the flood disabling techniques described herein. In block 410, a set of nodes managed by a management controller may be determined. As explained above, a management controller may be coupled to a defined set of nodes. All management traffic destined for those nodes is directed to the management controller. Thus, management software applications may believe they are communicating directly with a management controller situated on a node, when in fact the management software is communicating with a management controller that is shared between several nodes.

In block 420, node identifiers may be obtained for each of the identified nodes. In other words, for each node that is determined to be managed by the management controller, an identifier of that node is obtained. The node identifier may be a MAC address of the NIC on the production network in some example implementations. The techniques described herein are not dependent on any particular type of node identifier. What should be understood is that any identifier that can be used to determine to which node a communication is intended is suitable for use with the techniques described herein.

In block 430, an indication of the node identifiers may be sent to a network switch. The network switch may filter packets sent to the management controller based on the node identifiers. The network switch may further disable flooding to the management controller. In other words, the management controller may notify the network switch of nodes reachable through the management controller. The network switch may then only send traffic to the management controller that is destined for one of the nodes managed by the management controller. Because flooding is turned off, traffic not destined for a node managed by the management controller is not sent by the network switch to the management controller.

FIG, 5 is another example of a high level flow diagram for utilizing a management controller according to the flood disabling techniques described herein. In block 510, just as above in block 410, a set of nodes managed by a management controller may be determined. In block 520, just as in block 420, node identifiers for each of the identified nodes may be obtained.

The network switch may need to be informed of nodes associated with the management controller. Block 530 is one example implementation in which a packet is sent from the management controller to the network switch for each node in the set of nodes. The packet may include the node identifier wherein the network switch associates the node identifier with a port from which the packet was received. In other words, the management controller sends a packet for each node managed by the management controller to the network switch. The network switch then associates the port over which the packets were received with each of the received node identifiers.

Another example implementation is described in block 540, in which the node identifiers are sent to the network switch over an out of band interface. A similar result may be achieved in that the network switch is informed as to which nodes are associated with the management controller. However, unlike the implementation described in block 530, the management controller may notify the switch over an interface separate from the actual pod connecting the network switch to the management controller. What should be understood is that regardless of implementation, the network switch is informed of the nodes that are reachable over the port connected to the management controller.

In block 550, a network interface controller of the management controller may be configured to operate in promiscuous mode. As explained above, in promiscuous mode, every packet received by the NIC is passed to the operating system of the management controller, which then determines if the packet is destined for a node associated with the management controller. In block 560, a wake on LAN packet including the node identifier may be received.

As was explained above, because the network switch is configured to only allow traffic that is destined for nodes associated with the management controller to be sent to the management controller, it can be ensured that any WoL packet that is received by the management controller is actually destined for a node associated with the management controller. In block 570, the management controller may cause the node to wake up. In one example implementation, causing the node to wake up may include block 580, in which the node is powered on.

We claim:

1. A non-transitory processor readable medium containing a set of processor executable instructions thereon, which when executed by the processor cause the processor to:
receive, at a network switch, a plurality of node identifiers, the node identifiers identifying nodes reachable via a port of the network switch;
disable flooding on the port; and
send, on the port, traffic destined for nodes reachable via the port

2. The medium of claim 1 wherein the instructions to receive the plurality of node identifiers further comprises instructions which cause the processor to:
receive a communication from a chassis manager for each node of the plurality of nodes, the communication including the node identifier; and
for each node, associate the node identifier with the port of the network switch.

3. The medium of claim 1 wherein the instructions to receive the plurality of node identifiers further comprises instructions which cause the processor to:
receive a communication from the chassis manager, the communication including a list of nodes and the node identifier associated with each node in the list; and
for each node, associate the node identifier e port of the network switch.

4. The medium of claim 1 wherein node identifiers are media access control (MAC) addresses.

5. The medium of claim 4 wherein the MAC address is the MAC address of a network interface controller (NIC) of the node that is connected to a production network.

6. The medium of claim 5 further comprising instructions which cause the processor to:
receive a Wake on Lan (WoL) packet destined for one of the plurality of nodes, the WoL packet including the MAC address of the production network NIC of the node; and
send the WoL packet on the port associated with the node.

7. A method comprising:
determining a set of nodes managed by a management controller:
obtaining node identifiers for each of the identified nodes; and
sending an indication of the node identifiers to a network switch, the network switch filtering packets sent to the management controller based on the node identifiers, the network switch further disabling flooding of the management controller.

8. The method of claim 7 wherein sending the indication of the node identifiers further comprises:
sending a packet from the management controller to the network switch for each node in the set of nodes, the packet including the node identifier, wherein the network switch associates the node identifier with a port from which the packet was received.

9. The method of claim 7 wherein sending the indication of the node identifiers further comprises:
sending the node identifiers to the network switch over n out of band interface.

10. The method of claim 7 further comprising:
configuring a network interface controller of the management controller to operate in promiscuous mode. 11, The method of claim 10 further comprising:
receiving a Wake on Lan (WoL) packet including the node identifier of one node of the set of nodes; and
causing the node to wake up.

12. The method of claim 11 wherein causing the node to wake up inc des:
powering on the node.

13. A system comprising:
a network switch, the network switch including a plurality of ports, at east one port connected to an external network, the network switch receiving an indication of node identifiers associated with a port of the plurality of ports, each node identifier associated with a node:
a chassis manager, the chassis manager coupled to a port of the network switch through a network interface controller (NIC) of the chassis manager, the NIC of the chassis manager to operate in promiscuous mode, the chassis manager to further send node identifiers of nodes associated with the chassis manager to the network switch; and
the plurality of nodes coupled to the chassis manager, wherein the network switch forwards packets including the node identifier on the port associated with the node identifier to the chassis manager.

14. The system of claim 13 wherein the chassis manager further responds to a Wake on LAN (WoL) packet including a node identifier by powering on the node associated with the node identifier included in the WoL packet.

15. The system of claim 13 wherein the network switch does not flood the port connected to the chassis manager.
